(19) United States
(12) Patent Application Publication
(10) Pub. No.: US 2017/0046779 A1
(43) Pub. Date: Feb. 16, 2017

(54) LONG STEP AND HEALTHY CREDIT LIMIT ENHANCEMENT BASED ON MARKOV DECISION PROCESSES WITHOUT EXPERIMENTAL DESIGN

(71) Applicant: INTERNATIONAL BUSINESS MACHINES CORPORATION, Armonk, NY (US)

(72) Inventors: Feng Cao, Shanghai (CN); Heng Cao, Yorktown Heights, NY (US); Yuan Ni, Shanghai (CN); Fei Su, Shanghai (CN)

(21) Appl. No.: 14/826,431

(22) Filed: Aug. 14, 2015

(51) Int. Cl. G06Q 40/02

(52) U.S. Cl. CPC G06Q 40/025

(57) ABSTRACT

A method, a computer program product, and a computer system for making a decision of long step and healthy credit limit enhancement. A computer constructs a Markov decision process graph which includes nodes and edges, wherein the nodes represent respective states of one or more customer segments and the edges represent paths based on historical data. The computer applies long step actions for a respective one of the one or more customer segments, wherein the long step actions enhance more than one credit limit levels. The computer calculates gained values of the long step actions. The computer chooses an optimal long step action from the long step actions, wherein the optimal long step action has a maximum gained value.

### TECHNICAL FIELD OF THE INVENTION

The present invention relates generally to computer implemented financial analytics, and more particularly to a computer implemented method for long step and healthy credit limit enhancement based on Markov decision processes (MDPs) without experimental design.

### BACKGROUND

A credit limit is the maximum amount of credit that a financial institution or other lender will extend to a debtor for a particular line of credit (sometimes called a credit line, line of credit, or a tradeline). The credit limit is based on a variety of factors. Three primary factors are used by lenders to make decisions. The three primary factors include the credit score, the affordability, and the credit limit utilization. The credit score is a basic factor and an indication of how creditworthy a borrower is. The affordability is another basic factor. If a borrower has higher affordability, a lender will consider that the borrower is more creditworthy. The credit limit utilization is a factor which a lender periodically checks. By checking the credit limit utilization of a current credit card holder, a lender determines whether the credit limit should be increased or decreased.

In credit limit management, there are two main phases: credit limit assignment and credit limit enhancement. In credit limit assignment, based on customer's credit score, affordability, and previous credit limit utilization, an optimal credit limit is assigned to a customer or a customer segment. The credit limit is assigned to reach a profit goal. In credit limit enhancement, based on customer's credit score, previous credit limit utilization, and current credit limit utilization, the credit limit is enhanced for the customer or the customer segment. The credit limit enhancement will reach a profit enhancement goal. Actually, both the credit limit assignment and the credit limit enhancement are optimization issues. For example, one popular current algorithm for the optimization is the Markov decision process (MDP).

The conventional lenders leverage designed experimental strategies to explore regions never tested before, e.g., increase for an account with a risky score; however, they are not in accord with actual situations. Using the experimental design always encounters the efficiency problem, because many experimental treatments will be tested and the experimental periods are too long (normally 6 months, for example). Another popular method is the traditional Markov decision process which is a one-step action-effect model. It only considers the effect to the goal of one-appeared historic step action; therefore, it can only make existing one-step action but cannot make action decisions considering long steps and never appeared before. The Markov decision process considers backward influence of the credit limit; it does not consider the influence of the credit limit on credit risk and current utilization.

### SUMMARY

In one aspect, a method for making a decision of long step and healthy credit limit enhancement is provided. The method is implemented by a computer. The method includes constructing a Markov decision process graph which includes nodes and edges, wherein the nodes represent respective states of one or more customer segments and the edges represent paths based on historical data. The method includes applying long step actions for a respective one of the one or more customer segments, wherein the long step actions enhance more than one credit limit levels. The method includes calculating gained values of the long step actions. The method includes choosing an optimal long step action from the long step actions, wherein the optimal long step action has a maximum gained value.

In another aspect, a computer program product for making a decision of long step and healthy credit limit enhancement is provided. The computer program product comprises a computer readable storage medium having program instructions embodied therewith. The program instructions are executable to construct a Markov decision process graph which includes the nodes representing respective states of one or more customer segments and the edges representing paths based on historical data. The program instructions are executable to apply, for a respective one of the one or more customer segments, long step actions that enhance more than one credit limit levels. The program instructions are executable to calculate gained values of the long step actions. The program instructions are executable to choose an optimal long step action from the long step actions, wherein the optimal long step action has a maximum gained value.

In yet another aspect, a computer system for making a decision of long step and healthy credit limit enhancement is provided. The computer system comprises one or more processors, one or more computer readable tangible storage devices, and program instructions stored on at least one of the one or more computer readable tangible storage devices for execution by at least one of the one or more processors. The program instructions are executable to: construct a Markov decision process graph which includes the nodes representing respective states of one or more customer segments and the edges representing paths based on historical data; apply, for a respective one of the one or more customer segments, long step actions that enhance more than one credit limit levels; calculate gained values of the long step actions; and choose from the long step actions an optimal long step action which has a maximum gained value.

### BRIEF DESCRIPTION OF THE SEVERAL VIEWS OF THE DRAWINGS

FIG. 1 is a flowchart showing operational steps for making a decision of long-step and healthy credit limit enhancement, in accordance with one embodiment of the present invention.

FIG. 2 is a diagram illustrating an example of making a decision of long-step and healthy credit limit enhancement, in accordance with one embodiment of the present invention.

FIG. 3 is a diagram illustrating components of a computer device hosting one or more computer programs for making a decision of long-step and healthy credit limit enhancement, in accordance with one embodiment of the present invention.

### DETAILED DESCRIPTION

Embodiments of the present invention provide a computer implemented method for making a decision of long-step and healthy credit limit enhancement. The computer implemented method is based on the Markov decision process (MDP) and is without experimental design. In the computer implemented method, based on a credit score, credit utilization, and a corresponding assigned credit limit, a computer finds an optimal action of credit limit increase for a customer or customer segment, in order to achieve the goal of maximizing profit increase of future possible credit limit increase and optimizing status transition paths.

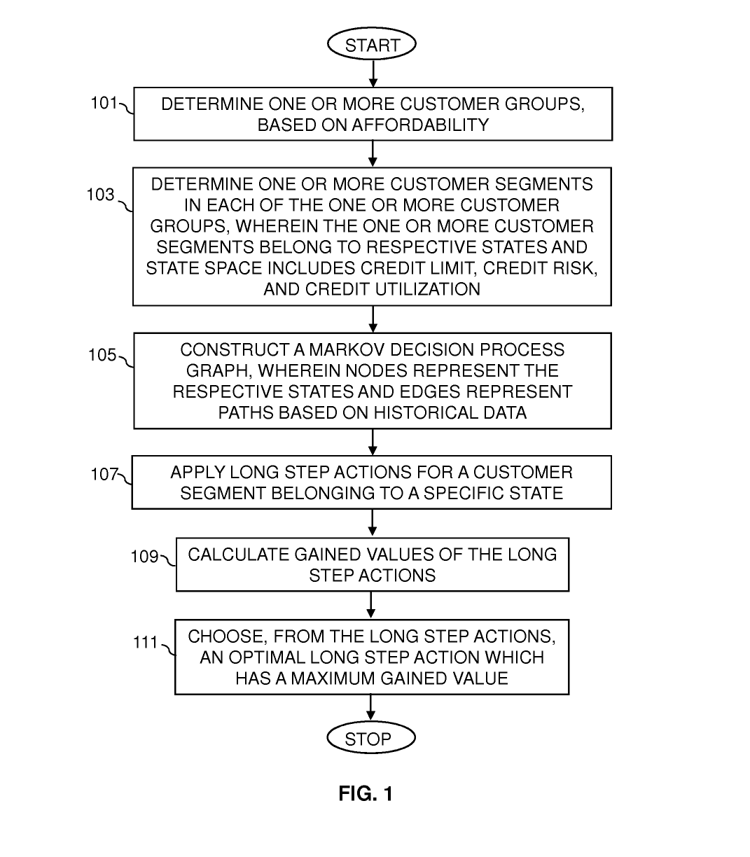

FIG. 1 is a flowchart showing operational steps for making a decision of long-step and healthy credit limit enhancement, in accordance with one embodiment of the present invention. At step 101, a computer determines one or more customer groups, based on affordability. Regarding the affordability, some factors, such as income, consumption, and existing loans, are considered. The one or more customer groups are not changeable during the credit limit enhancement.

At step 103, the computer determines one or more customer segments in each of the one or more customer groups. The one or more customer segments belong to respective states. Each of the one or more customer segments includes one or more customers. To ensure a long step Markov state transfer, the state space includes credit limit, credit risk, and credit utilization. For a specific one of the one or more customer groups, if the affordability is fixed, the credit risk and the credit utilization can be directly affected by the credit limit adjustment. Therefore, the long step Markov state transfer can reserve the influence of credit limit changes and thus it is safe to use the long step state transfer probability to reflect the skipped state transfers. State space is defined as <CL, R, U>, where CL is the assigned credit limit, R is the credit risk, and U is credit utilization. For example, R may have three levels: high risk (HR), medium risk (MR), and low risk (LR); U may have three levels: high utilization (HU), medium utilization (MU), and low utilization (LU).

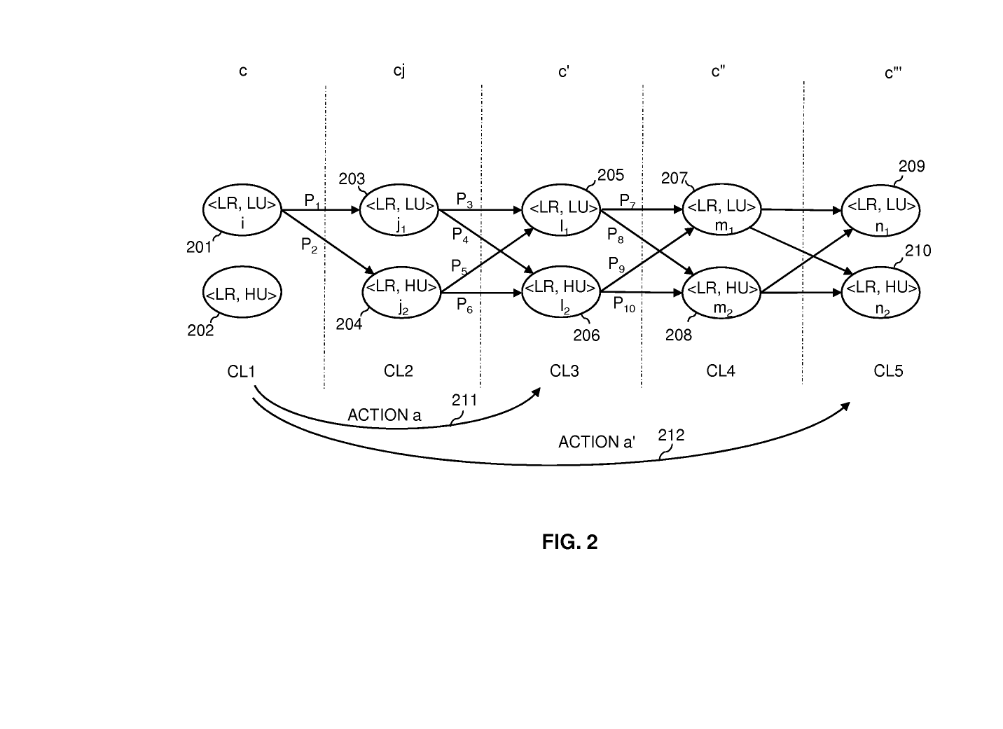

At step 105, the computer constructs a Markov decision process graph, wherein nodes represent the respective states and edges represent paths based on historical data. FIG. 2 shows an example of part of the Markov decision process graph. In the Markov decision process graph, each node represents a state to which a specific costumer segment belongs. Shown as in FIG. 2, for the first credit limit level CL1, there are two states: <LR, LU> 201 (or state i) and <LR, HU> 202; for the second credit limit level CL2, there are two states: <LR, LU> 203 (or state j₁) and <LR, HU> 204 (or state j₂); for the third credit limit level CL3, there are two states: <LR, LU> 205 (or state l₁) and <LR, HU> 206 (or state l₂); for the fourth credit limit level CL4, there are two states: <LR, LU> 207 (or state m₁) and <LR, HU> 208 (or state m₂); and the fifth credit limit level CL5, there are two states: <LR, LU> 209 (or state n₁) and <LR, HU> 210 (or state n₂). The edges denoted by dotted-lines connecting the states are historical paths taken by costumers. The probabilities and values of the respective paths are used to calculate gains of long step actions. Shown in FIG. 2, for example, the probability of the path between <LR, LU> 201 and <LR, LU> 203 is P₁, the probability of the path between <LR, LU> 201 and <LR, HU> 204 is P₂, the probability of the path between <LR, LU> 203 and <LR, LU> 205 is P₃, the probability of the path between <LR, LU> 203 and <LR, HU> 206 is P₄, the probability of the path between <LR, HU> 204 and <LR, LU> 205 is P₅, the probability of the path between <LR, HU> 204 and <LR, HU> 206 is P₆, the probability of the path between <LR, LU> 205 and <LR, LU> 207 is P₇, the probability of the path between <LR, LU> 205 and <LR, HU> 208 is P₈, the probability of the path between <LR, HU> 206 and <LR, LU> 207 is P₉, and the probability of the path between <LR, HU> 206 and <LR, HU> 208 is P₁₀.

At step 107, the computer applies long step actions for a customer segment belonging to a specific state (or a specific node on the Markov decision process graph). For example, as shown as in FIG. 2, for the customer segment belonging to <LR, LU> 201, computer applies action a (numeral 211) which jumps from the first credit limit level CL1 to the third credit limit level CL3 (or from state i under c to states l under c′), and computer applies action a′ (numeral 212) which jumps form the first credit limit level CL1 to the fifth credit limit level CL5 (or from state i under c to states n under c′″).

At step 109, the computer calculates gained values of the long step actions. For example, the computer calculates the gained values of action a (numeral 211) and applies action a′ (numeral 212) shown in FIG. 2. At step 111, the computer chooses, from the long step actions applied at step 109, an optimal action which has a maximum gained value. For example, the computer chooses an optimal action from action a (numeral 211) and action a′ (numeral 212) shown in FIG. 2.

For example, the gained value for long step action a 211 shown in FIG. 2 can be calculated by:

$${V}_{a} ( c , i ) = {max}_{{c}^{′}} ( {\sum }_{l ∈ {c}^{′}} P ( c , i ; {c}^{′} , l ) \cdot V ( {c}^{′} , l ) - R ( c , i ; {c}^{′} ) ) \qquad ( 1 )$$

In equation (1),

$${\sum }_{l ∈ {c}^{′}} P ( c , i ; {c}^{′} , l )$$

is a sum of the probabilities from state i under c to states l under c′. Long step action a 211 Jumps from state i under c to states l under c′. States l are all states under c′. For example, shown in FIG. 2, state i under c is node <LR, LU> 201, state l₁ under c′ is node <LR, LU> 205, and state l₂ under c′ is node <LR, HU> 206.

Each terms in

$${\sum }_{l ∈ {c}^{′}} P ( c , i ; {c}^{′} , l )$$

of equation (1) can be calculated by:

$$P ( c , i ; {c}^{′} , l ) = {\sum }_{j ∈ cj} P ( c , i ; cj , j ) \cdot P ( cj , j ; {c}^{′} , l ) \qquad ( 2 )$$

Each term of the summation in equation (2) is the multiplication of a probability of a path between state i under c and one of states j under cj (for example, P₁ between state i and state j₁ shown in FIG. 2) and a probability of a path between one of states j under cj and one of states l under c′ (for example, P₃ between state j₁ and state l₁ under c′ shown in FIG. 2). As an example, P(c,i; c′,l) in FIG. 2 can be calculated as:

P(c,i;c′,l)=P₁·P₃+P₁·P₄+P₂·P₅+P₂·P₆ (3)

In equation (1), V(c′,l) is the gained value for the customer segment belonging to <LR, LU> 201 at states l under c′ and it can be calculated by:

$$V ( {c}^{′} , l ) = ϕ \cdot T \cdot r ( {c}^{′} , l ) + ( {\sum }_{{c}^{′} -> {c}^{″}} {P}_{{c}^{′} -> {c}^{″}} ( {c}^{′} , l ; {c}^{″} , m ) \cdot V ( {c}^{″} , m ) ) \qquad ( 4 )$$

In equation (4), P_{c′→c″} is the probabilities of paths from states l (including, for example, state l₁ and state l₂ in FIG. 2) under c′ to states m (including, for example, state m₁ and state m₂ in FIG. 2) under c″; for example, P₇, P₈, P₉, and P₁₀ in FIG. 2. V(c″, m) is the gained value for the customer segment belonging to <LR, LU> 201 at states m under c″. In equation (4), T is the number of steps which are skipped by applying a long step action; for example, in FIG. 2, applying action a 211 skips cj (or the second credit limit level CL2). In the equation (4), φ is a factor of punishment for skipping steps, 0<φ<1. In equation (4), r(c′,l) is the reward gained by all customer segments in states l under c′. For each customer segment, the reward gained can be calculated by:

CL×CU×(1−(default rate))×(interest rate) (5)

where CL is the credit limit and CU is the credit utilization.

In equation (1), R(c,i;c′) is the reward gained by the customer segment at state i and transferred from c to c′. R(c,i;c′) can be calculated by

$$R ( c , i ; {c}^{′} ) = r ( c , i ) + ( {\sum }_{j ∈ ( cj )} P ( c , i ; j ) \cdot R ( cj , j ; {c}^{′} ) ) \qquad ( 6 )$$

Calculating the gained value of long step action a′ 212 shown in FIG. 2 follows the same method shown in previous paragraphs where calculating the gained value of action a 211 is presented. The computer applies more long-step actions (which are not shown in FIG. 2) of credit limit enhancement, and the computer calculates gain values of the more long-step actions by using the same method of calculating the gained value of long step action a 211.

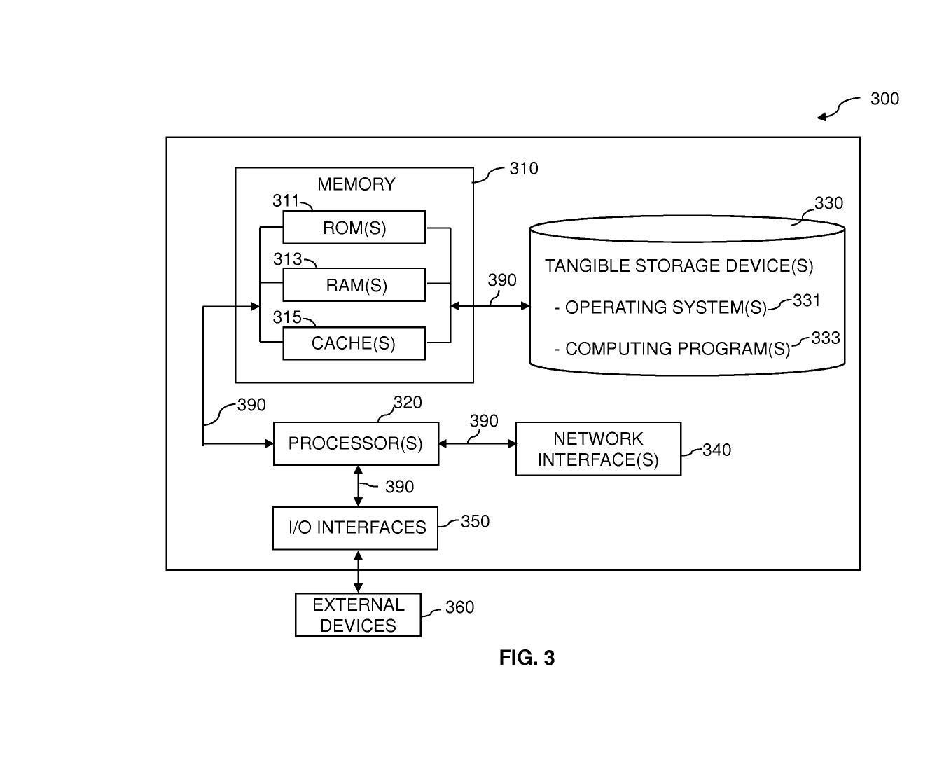

FIG. 3 is a diagram illustrating components of computer device 300 hosting one or more computer programs for making a decision of long-step and healthy enhancement of a credit limit, in accordance with one embodiment of the present invention. It should be appreciated that FIG. 3 provides only an illustration of one implementation and does not imply any limitations with regard to the environment in which different embodiments may be implemented.

Referring to FIG. 3, computer device 300 includes processor(s) 320, memory 310, and tangible storage device(s) 330. In FIG. 3, communications among the above-mentioned components of computing device 300 are denoted by numeral 390. Memory 310 includes ROM(s) (Read Only Memory) 311, RAM(s) (Random Access Memory) 313, and cache(s) 315. One or more operating systems 331 and one or more computer programs 333 reside on one or more computer readable tangible storage device(s) 330. The computer programs for making a decision of long-step and healthy credit limit enhancement resides on one or more computer readable tangible storage device(s) 330. Computing device 300 further includes I/O interface(s) 350. I/O interface(s) 350 allows for input and output of data with external device(s) 360 that may be connected to computing device 300. Computing device 300 further includes network interface(s) 340 for communications between computing device 300 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the “C” programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the FIGs illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for making a decision of long step and healthy credit limit enhancement, the method comprising:
constructing, by a computer, a traditional Markov decision process graph including nodes representing respective states of one or more customer segments and edges representing paths based on historical data;
applying, by the computer, long step actions for a respective one of the one or more customer segments, each of the long step actions skipping one or more steps in the traditional Markov decision process so as to enhance more than one credit limit levels;
calculating, by the computer, gained values of the long step actions; and
choosing, by the computer, an optimal long step action from the long step actions, the optimal long step action having a maximum gained value.

2. The method of claim 1, further comprising:
determining, by the computer, one or more customer groups, based on affordability of customers; and
determining, by the computer, the one or more customer segments in each of the one or more customer group.

3. The method of claim 1, wherein space of the respective states of the one or more customer segments comprises credit limits, credit risk, and credit utilization.

4. The method of claim 1, wherein the Markov decision process graph comprises multiple credit limit levels and each of the multiple credit limit levels comprises multiple levels of credit risk and multiple levels of credit utilization.

5. The method of claim 4, wherein the multiple levels of the credit risk comprise high credit risk, medium credit risk, and low credit risk.

6. The method of claim 4, wherein the multiple levels of credit utilization comprise high credit utilization, medium credit utilization, and low credit utilization.

7. The method of claim 1, wherein the gained values are calculated based on probabilities of the paths based on historical data, values at the respective states, and rewards gained at a low credit limit level and transferred from the low credit limit level to a high credit limit level.

8. A computer program product for making a decision of long step and healthy credit limit enhancement, the computer program product comprising a computer readable storage medium having program instructions embodied therewith, the program instructions executable to:
construct a traditional Markov decision process graph including nodes representing respective states of one or more customer segments and edges representing paths based on historical data;
apply long step actions for a respective one of the one or more customer segments, each of the long step actions skipping one or more steps in the traditional Markov decision process so as to enhance more than one credit limit levels;
calculate gained values of the long step actions; and
choose an optimal long step action from the long step actions, the optimal long step action having a maximum gained value.

9. The computer program product of claim 8, further comprising the program instructions executable to:
determine one or more customer groups, based on affordability of customers; and
determine the one or more customer segments in each of the one or more customer group.

10. The computer program product of claim 8, wherein space of the respective states of the one or more customer segments comprises credit limits, credit risk, and credit utilization.

11. The computer program product of claim 8, wherein the Markov decision process graph comprises multiple credit limit levels and each of the multiple credit limit levels comprises multiple levels of credit risk and multiple levels of credit utilization.

12. The computer program product of claim 11, wherein the multiple levels of the credit risk comprise high credit risk, medium credit risk, and low credit risk.

13. The computer program product of claim 11, wherein the multiple levels of credit utilization comprise high credit utilization, medium credit utilization, and low credit utilization.

14. The computer program product of claim 8, wherein the gained values are calculated based on probabilities of the paths based on historical data, values at the respective states, and rewards gained at a low credit limit level and transferred from the low credit limit level to a high credit limit level.

15. A computer system for making a decision of long step and healthy credit limit enhancement, the computer system comprising:
one or more processors, one or more computer readable tangible storage devices, and program instructions stored on at least one of the one or more computer readable tangible storage devices for execution by at least one of the one or more processors, the program instructions executable to:
construct a traditional Markov decision process graph including nodes representing respective states of one or more customer segments and edges representing paths based on historical data;
apply long step actions for a respective one of the one or more customer segments, each of the long step actions skipping one or more steps in the traditional Markov decision process so as to enhance more than one credit limit levels;
calculate gained values of the long step actions; and
choose an optimal long step action from the long step actions, the optimal long step action having a maximum gained value.

16. The computer system of claim 15, further comprising the program instructions executable to:
determine one or more customer groups, based on affordability of customers; and
determine the one or more customer segments in each of the one or more customer group.

17. The computer system of claim 15, wherein space of the respective states of the one or more customer segments comprises credit limits, credit risk, and credit utilization.

18. The computer system of claim 15, wherein the Markov decision process graph comprises multiple credit limit levels and each of the multiple credit limit levels comprises multiple levels of credit risk and multiple levels of credit utilization.

19. The computer system of claim 18, wherein the multiple levels of the credit risk comprise high credit risk, medium credit risk, and low credit risk, wherein the multiple levels of credit utilization comprise high credit utilization, medium credit utilization, and low credit utilization.

20. The computer system of claim 15, wherein the gained values are calculated based on probabilities of the paths based on historical data, values at the respective states, and rewards gained at a low credit limit level and transferred from the low credit limit level to a high credit limit level.
